(19) United States
(12) Patent Application Publication
(10) Pub. No.: US 2020/0215716 A1
(43) Pub. Date: Jul. 9, 2020

(54) Ergonomic Interchangeable Gouger Guide with Vertical Height Adjustment

(71) Applicant: Pierre Roy, Amherst, NY (US)

(72) Inventor: Pierre Roy, Amherst, NY (US)

(21) Appl. No.: 16/242,265

(22) Filed: Jan. 8, 2019

(51) Int. Cl. B27J 1/00; G10D 9/02

(52) U.S. Cl. CPC B27J 1/00; G10D 9/023

(57) ABSTRACT

The double reed gouger, is a machine that has been used as a means to accurately and effectively remove excess material from within the concave structure of the split and measured double reed cane. This machine process is essential to the production of the double reed, when inserted into applicable instrument, is able to reproduce a specific vibration from within the cane to enable the player to easily and without much effort perform notes with ease of vibration and accuracy of pitch. The double reed gouging machine particularly for the Oboe, Oboe D′amore, English horn and Bassoon Family of instruments is in need of major upgrades to it's usefulness, accuracy and comfort by way of modern machining and design. This is a continuation of such efforts.

### CROSS REFERENCED TO RELATED APPLICATIONS

NA

### STATEMENT REGARDING FEDERALLY SPONSORED RESEARCH OR DEVELOPMENT

NA

### REFERENCE TO SEQUENCE LISTING

NA

### BACKGROUND OF THE INVENTION

This utility application pertains to the use of a device that aids in the construction of a double reed. The double reed is a musical device which when made properly vibrates against itself to produce a sound and tone. These double reeds are used to create the sound of double reed woodwind instruments known as Oboes, Bassoons, to an extent other musical instruments like the Bagpipe, Shawm and supplementary exotics.

The difficulty of performing these aforementioned musical instruments is directly linked to the satisfactory production of the vibrating reed. It is well known throughout the musical world that the oboe is one of the most difficult instruments to play and this is mostly because the reed can be counter productive. Other double reed instruments are almost as equally difficult in producing a satisfactory and comfortable vibrating reed.

The device set forth is designed to help the reed become more manageable and consistent in it's making by eliminating difficulties at the most critical juncture of the reed, and that is the gouging process.

Gouging double reed cane determines properties of the reed that cannot be altered through the external scraping of the reed. These properties include the strength of the opening and the force by which the reed holds itself together. Moreover a great deal of the tone of the instrument, as well as the vibrancy and response of the reed, is also determined by the gouge.

The device henceforth is designed as a double radius gouge, meaning the use of two separate curves that are involved when gouging as the reed cane is flipped periodically to create a curve that is slightly offset. For the design of the machine essentially limits cane removal to one side. The combination of offset curves for each side produces a wider arc in the gouged cane much like that of a Romanesque bridge or Ancient Roman Aqueduct. This style of gouging produces considerable strength that is determined by the curve and thickness of the center and it's relationship to the gouged sides.

The double radius gouge for oboe reeds is primarily a convention of American oboe players in particular that require a stronger opening in the reed because more cane is removed from the external portion of the reed than their European counterparts.

This utility device specifically addresses three major factors when gouging; interchangeable guides, the use of a special vertical screw device for very specific height adjustment and the ergonomics involved when gouging by hand.

### BRIEF SUMMARY OF INVENTION

As previously stated the strength, vibrancy and tone of the double reed is predetermined by the gouge. In order to enhance the overall performance of the double reed with regard to the oboe and other forms of the instrument the invention described here has fundamental alterations to traditional practices that has a significant impact on the ease of use, adjustment and overall result of the gouging machine. These inventions are an attempt to bring modern machinery, design and function to an historical means of gouging that has been previously addressed with simple outdated and unaesthetic means of machining.

Because the gouge is so dependent upon the design of the curve of the gouger, known as the guide, this invention departs from old ideas by allowing the guide to be interchangeable. Meaning that not only the curve of the blade can be altered but hitherto the most important aspect of the double reed gouge which has not been previously addressed, is the ability to swap a guide, which feeds the blade to cut the cane, to be changed for another curved guide.

Height of the bed adjustment is also addressed in this invention by allowing the user to change the height and thereby the thickness of the gouge by a simple means. Previous machines used a horizontal or bearing style of height adjustment, which is cumbersome and time consuming. This invention allows the user to change the height at will throughout the process of gouging without stopping to adjust height with wrenches and screws etc. This height adjustment uses a very precise and simple means that can be changed “on the fly”.

The final invention of the guide carriage as it is called is the usage of premiere design software, which enables modern CNC machining to impose ergonomics onto the design and function influencing the comfort and ease of gouging for the user. This previously has only been addressed by the use of a cumbersome knob style handle. The knob is outdated and does not give the cutting feedback necessary for the user. The ergonomics of the design reduces the discomfort of sharply machined edges and allows for the application of the necessary force required to gouge down and through the cane in a much smoother manner. It enhances the experience by being more connected to the material.

### BRIEF DESCRIPTION OF THE SEVERAL VIEWS OF THE DRAWINGS

There are seven figures included, which will describe the overall and specific means by which this invention introduces new conventions.

For simplicity and brevity the gouger example that is used will be the one designated for Oboe gouging.

FIG. 1

This view shows the Oboe gouger overview showing the relationship of the guide to the complete machine excluding linear bearing in guide carriage for guide rod. The entire guide component moves in a linear fashion to plane a piece of wood, in the plane bed, known as cane.

The gouger is essentially a manual curved blade repetitive planer device.

FIG. 2

Front of gouger guide carriage with attached guide and roller plate showing the locations of the various components.

FIG. 3

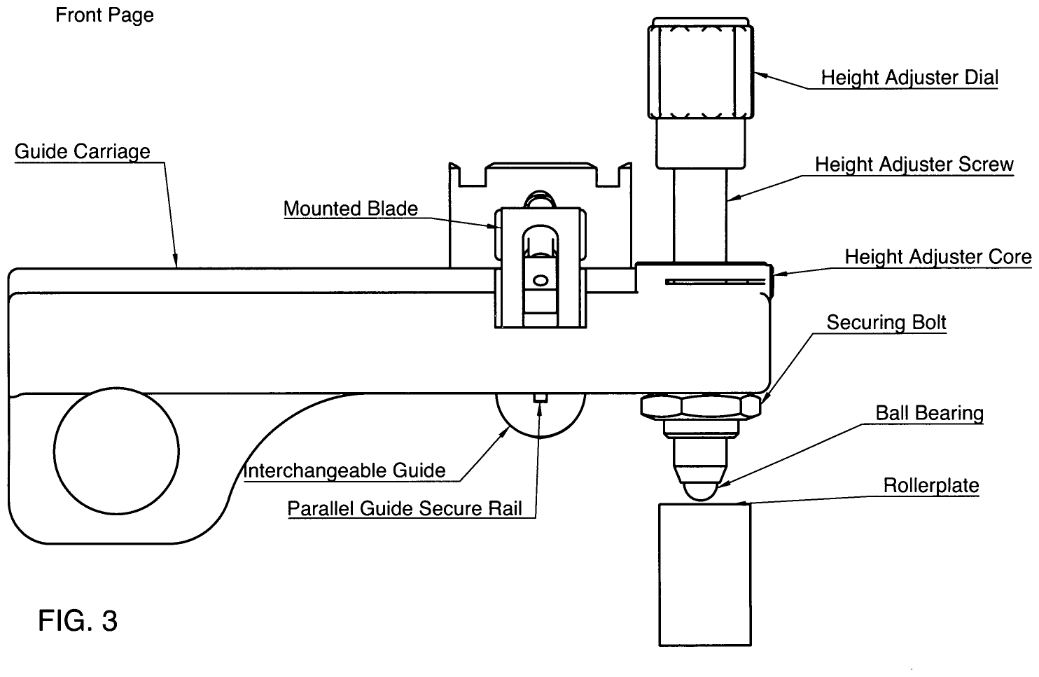

Left side of gouger guide carriage with attached guide and roller plate also showing locations of the various components. Notice the bottom of blade not clearly visible due to the fine nature of the gouge.

FIG. 4

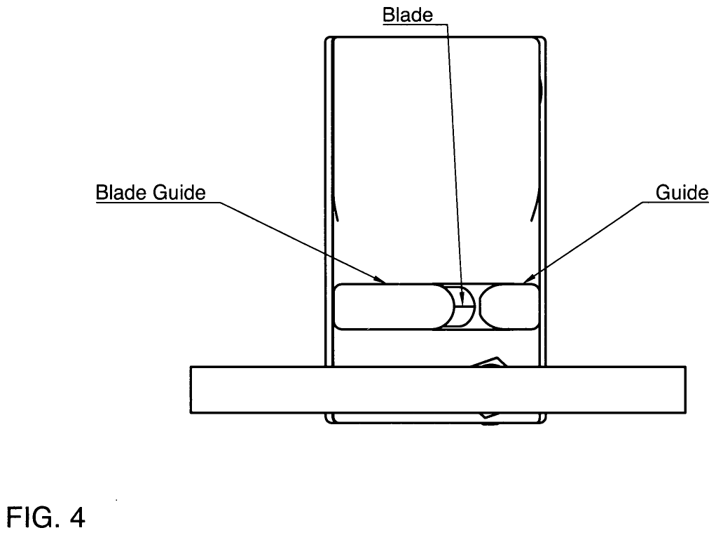

In this drawing the Underside (bottom) of gouger guide and roller plate showing the location of guide and blade.

FIG. 5

Top view of gouger guide carriage with attached guide indicating guide attachment screw locations viewed through various components.

FIG. 6

Gouger guide and guide carriage only with indicated attachment and screw points.

FIG. 7

This drawing is an exploded view of the fine vertical height adjustment device.

### DETAILED DESCRIPTION OF THE INVENTION

Though the art and practice of gouging cane for oboe reeds and other double reed instruments in the music world and industry is very old and can be traced to the origins of early western music, the way in which double reed cane has been gouged has remained almost as equally ancient. The gouging of cane has not changed dramatically since the industrial age in France and therefore it has become commonplace for machinists to manufacture this oddity according to custom. Very few improvements of design have been made to the machine in this modern era of computer control.

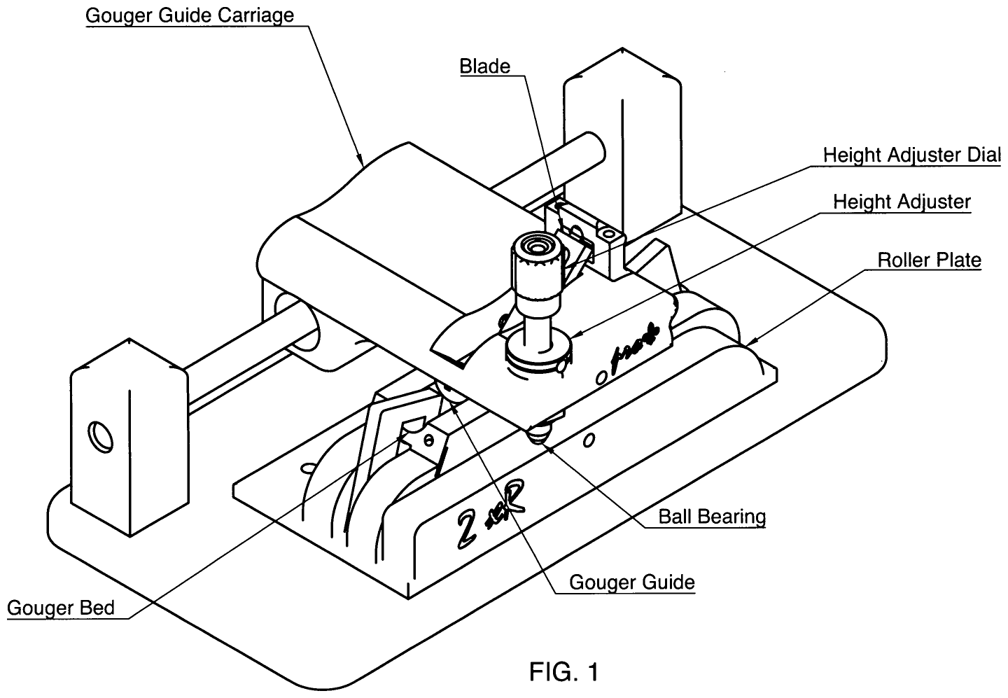

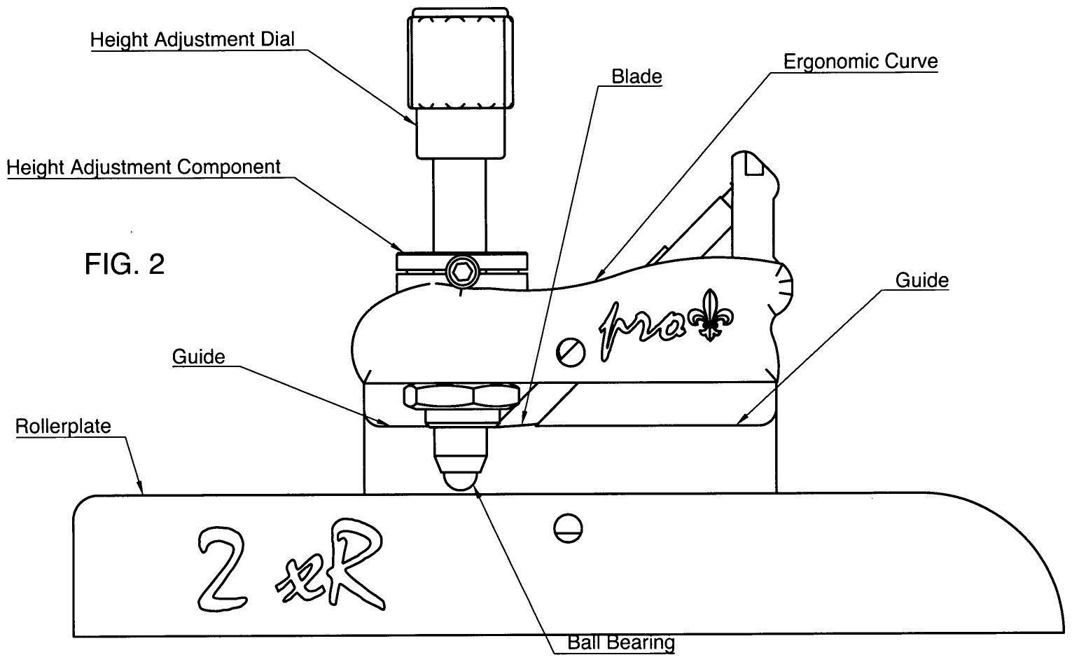

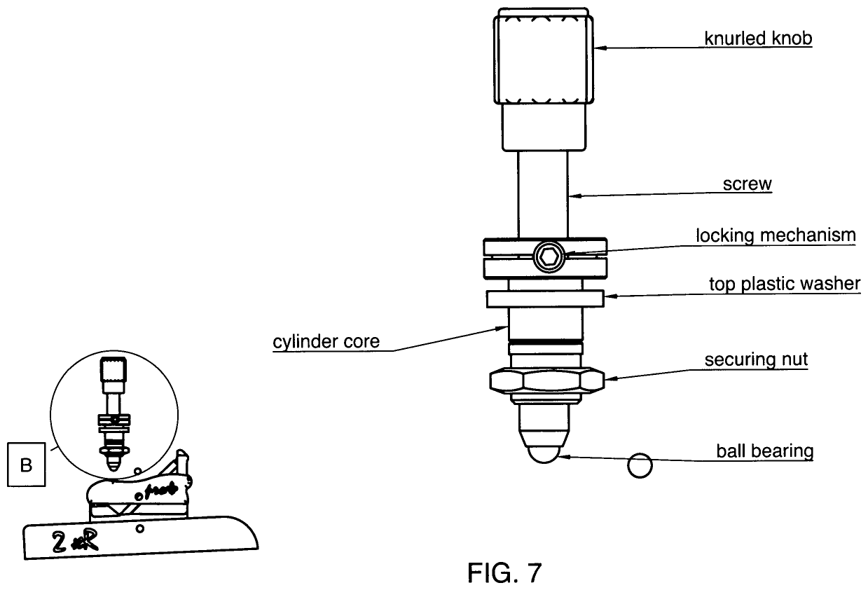

Early machines had used two plates rubbing against one another as a means of height control and some examples may be found in German gougers of the early twentieth century. A universal improvement was made for the height control by substituting an adjustable wheel bearing rolling on a plate to improve the bottoming out of the gouge. This gouger guide design departs from both methods by introducing an adjustable height adjuster that may be adjusted while the gouge is in motion. This height adjustment feature includes a ball bearing magnetically attached to the screw of the adjuster, the screw portion is finely threaded to allow for gradual increase and decrease in height. A quarter turn of the adjustment knob equals approximately 0.01 mm in height difference enabling the user to gauge very fine increments in gouging. The adjuster has a locking mechanism by means of a grub screw that separates the thread distance when preventing the adjustment screw from turning. This locking mechanism may or may not be used while the machine is working so that the user may adjust height on the fly when unlocked (unscrewed). FIG. 2 shows a view of how this mechanism is engaged. The height adjustment knob or dial is turned clockwise viewing from the top down (FIG. 1) to increase the height of the gouge and counter clockwise to reduce the height thereby making the gouged cane thinner. A detailed view of the height adjustment component can be seen in FIG. 7. The height adjustment component is composed of several machined parts one of which is the core that enables the adjuster to be securely fastened to the guide carriage through a hole in the guide carriage over the roller plate area. The locking mechanism as well as the long adjusting screw, ball bearing and dial knob complete the component. The height adjustment mechanism is securely fastened via a washer and bolt on the underside of the carriage to the core component as seen in FIG. 2.

The ball bearing is oiled with light oil that enables it to roll smoothly as the gouge bottoms out according to this height adjustment.

The second improvement on convention is related to the gouger guide itself. The guide is the curve of brass or aluminum that feeds the wood of the double reed cane to the blade in very fine increments. Machinist previously would machine the guide and the guide carriage as one component. Therefore, the radius of the guide itself, which is crucial in the gouging of the cane, was unalterable and the only improvement or change one could have would be to machine an entire guide carriage and guide with a different curve. Also, these curves in the guide sometimes are worn over time and need to be exchanged.

This gouger guide design has solved both issues by allowing the guide itself to be removed from the guide carriage and replaced with either a new guide or one of a different radii combination to create reeds with different tonal and performance properties.

This design is not only applicable to the oboe gouger but in fact any and all gouging machines that employ the same form of cane removal which includes but not limited to Oboe D′amore, English Horn, Bass oboe, Baritone oboe, Heckelphone, Bassoon, Contrabassoon and forms of reed making devices for various bagpipe instruments as well.

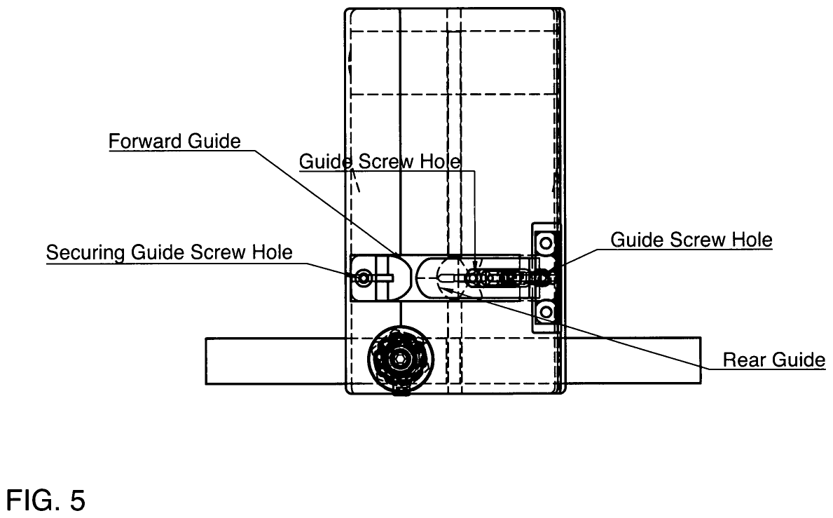

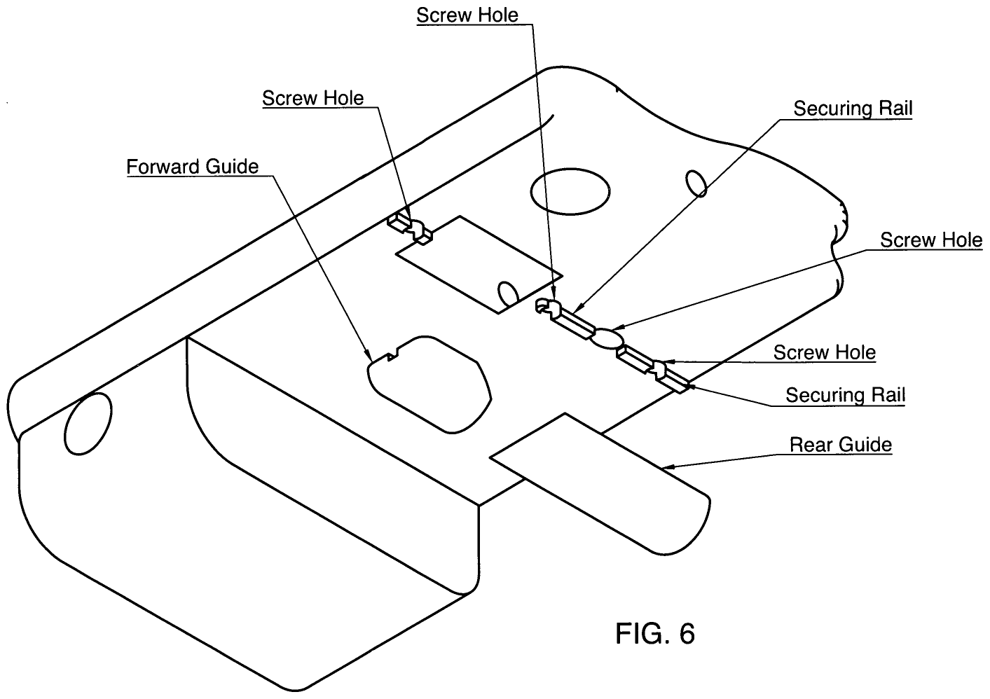

FIG. 5 shows the connection points where the guide is secured by screws to the guide carriage. FIG. 6 gives a view of how the underside of the guides fit onto the extruded Carriage rails and is securely fastened.

The third invention not utilized or a reflection of any occurrence is with respect to the ergonomics of the gouging machine.

Many machines are made with hard corners and flat surfaces that are difficult to grasp, handle and fatiguing to certain areas of the hand or fingers of the hand when using. This is particularly true of hard (sharp) corners of machined brass, steel or aluminum that does not provide relief with extended usage.

This design helps to mitigate fatigue and discomfort by the introduction of many curved surfaces and angles of address that enable the user to use the gouger with ease and eliminates the requirement of a handle. The ability to actually feel the cane being removed connects the user with the material in a way that provides better feedback and overall a much better experience when gouging the cane. FIG. 2 shows a definition of the curve on the top of the guide carriage for placement of the fingers. This is where the forefingers are placed as the machine is pushed back and forth with a smooth and even motion. The rear top of the carriage is also curved to accommodate thumb placement. Having a delineated surface such as this on the top of the carriage shows the potential of ease for the user.

This combination of the guide, blade and height adjuster with an ergonomic factor brings about a harmonious interaction of surfaces with the result being fluidity of use and excellence of the finished product.

1. This double reed gouging machine design employs the use of an interchangeable guide.

2. This double reed gouging machine design utilizes a form of height adjustment through the use of a vertical screw mechanism.

3. This double reed gouging machine design promotes healthy ergonomics, which minimizes fatigue and mitigates discomfort when using manually without the assistance of a handle.
